(19) United States
(12) Patent Application Publication
(10) Pub. No.: US 2013/0322057 A1
(43) Pub. Date: Dec. 5, 2013

(54) HEAT TRANSFER CAP AND REPAIRING APPARATUS AND METHOD

(71) Applicant: FUJITSU LIMITED, Kawasaki-shi (JP)

(72) Inventors: Toru OKADA, Yokohama (JP); Hiroshi KOBAYASHI, Kawasaki (JP); Takumi MASUYAMA, Kawasaki (JP)

(73) Assignee: FUJITSU LIMITED, Kawasaki-shi (JP)

(21) Appl. No.: 13/901,152

(22) Filed: May 23, 2013

(30) Foreign Application Priority Data
Jun. 1, 2012 (JP) 2012-126212

(51) Int. Cl. F28F 9/00; F21V 33/00

(52) U.S. Cl. CPC F28F 9/00; F21V 33/0084
USPC 362/92; 165/185

(57) ABSTRACT

There is provided a heat transfer cap includes a cap unit configured to include side walls to be in contact with side surfaces of an electronic component during heating, the cap unit covering the electronic component solder-jointed to a wiring board, and a ring unit mounted outside side walls of the cap unit, a linear expansivity of the ring unit being smaller than a linear expansivity of the cap unit.

### CROSS-REFERENCE TO RELATED APPLICATION

This application is based upon and claims the benefit of priority of the prior Japanese Patent Application No. 2012-126212, filed on Jun. 1, 2012, the entire contents of which are incorporated herein by reference.

### FIELD

The embodiments discussed herein are related to a heat transfer cap, a repairing apparatus, and a repairing method.

### BACKGROUND

In a printed board unit in which a semiconductor package such as a ball grid array (BGA) is mounted on a printed board, the semiconductor package may be replaced (repaired) at the time of, for example, manufacture or maintenance, when the semiconductor package has a defect or failure. In this case, a repairing apparatus is used to remove the semiconductor package having a defect or failure from the printed board and mount a semiconductor package not having a defect or failure on the printed board.

An example of this repairing apparatus uses a scheme of heating and melting solder joint parts of a semiconductor package for removal from a printed board by blowing hot air. However, in this repairing apparatus, at the time of heating by hot air, the temperature of an electronic component such as a semiconductor package or a semiconductor chip provided around the semiconductor package as a replacement target component increases, thereby adding unwanted heat history. For this reason, quality assurance of the printed board unit is difficult.

In particular, for a lead-free bonding material, SnAgCu (SΔC) solder containing tin, silver, and copper is used as lead-free solder, for example. SΔC solder has a melting point of approximately 220° C., which is higher than the melting point, approximately 183° C., of eutectic solder containing tin and lead (approximately 183° C.) by approximately 40° C. Also, with products being made smaller and thinner, the gap between the semiconductor package as a replacement target component and a surrounding electronic component has become narrower, for example, from approximately 5 mm to approximately 0.5 mm. For this reason, the temperature of the surrounding electronic component is further increased when using above scheme, and quality assurance of the printed board unit has become more difficult. Moreover, a hot air nozzle for use in blowing hot air may interfere with the surrounding electronic component.

The inventor has suggested a repairing apparatus capable of reducing heat influences to the surrounding electronic component (for example, refer to Japanese Laid-open Patent Publication No. 2011-211073). In this repairing apparatus, with a heat transfer cap abutting on an upper surface of the electronic component (for example, an upper surface of a package board of a semiconductor package), the heat transfer cap is radiated with light to be heated, thereby melting solder joint parts of the electronic component.

Japanese Laid-open Patent Publication No. 2010-10359 is another example of related art.

### SUMMARY

According to an aspect of the invention, a heat transfer cap includes a cap unit configured to include side walls to be in contact with side surfaces of an electronic component during heating, the cap unit covering the electronic component solder-jointed to a wiring board, and a ring unit mounted outside side walls of the cap unit, a linear expansivity of the ring unit being smaller than a linear expansivity of the cap unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic perspective view of the structure of a heat transfer cap according to an embodiment;

FIG. 2 is a schematic perspective view of the structure of a cap unit configuring the heat transfer cap according to the present embodiment;

FIG. 3 is a schematic perspective view of the structure of a modification example of the cap unit configuring the heat transfer cap according to the present embodiment;

FIG. 4 is a schematic sectional view of the structure of another modification example of the cap unit configuring the heat transfer cap according to the present embodiment;

FIG. 5A is a schematic sectional view for describing a deforming mechanism in the heat transfer cap according to the present embodiment, depicting the state at normal temperatures;

FIG. 5B is a schematic sectional view for describing the deforming mechanism in the heat transfer cap according to the present embodiment, depicting the state at the time of heating;

FIG. 6 is a drawing that depicts calculation results of a displacement amount ΔS at a tip of each side wall of the cap unit, a displacement amount ΔC for contribution as a gripping force, and a gripping force F in an example of a specific structure of the heat transfer cap according to the present embodiment;

FIG. 7 is a schematic view of the structure of a repairing apparatus according to the present embodiment, depicting the state with a suction nozzle retracting;

FIG. 8 is a schematic view of the structure of the repairing apparatus according to the present embodiment, depicting the state with the heat transfer cap being suctioned by a suction nozzle;

FIG. 9 is a control block diagram for describing control to be performed in the repairing apparatus according to the present embodiment;

FIG. 10A is a flowchart for describing a repairing method to be performed by using the repairing apparatus according to the present embodiment and specifically for describing a method of removing an electronic component;

FIG. 10B is a flowchart for describing the repairing method to be performed by using the repairing apparatus according to the present embodiment and specifically for describing a method of mounting an electronic component;

FIG. 11 is a schematic sectional view of the structure of still another modification example of the cap unit configuring the heat transfer cap according to the present embodiment;

FIG. 12 is a schematic sectional view of the structure of yet another modification example of the cap unit configuring the heat transfer cap according to the present embodiment;

FIG. 13 is a schematic sectional view of the structure of yet another modification example of the cap unit configuring the heat transfer cap according to the present embodiment;

FIG. 14A is a schematic sectional view of the structure of a multi-chip package with mounted components exposed; and

FIG. 14B is a schematic sectional view of the structure of a multi-chip package with a package cover mounted thereon.

### DESCRIPTION OF EMBODIMENTS

Preliminary Consideration

Problems

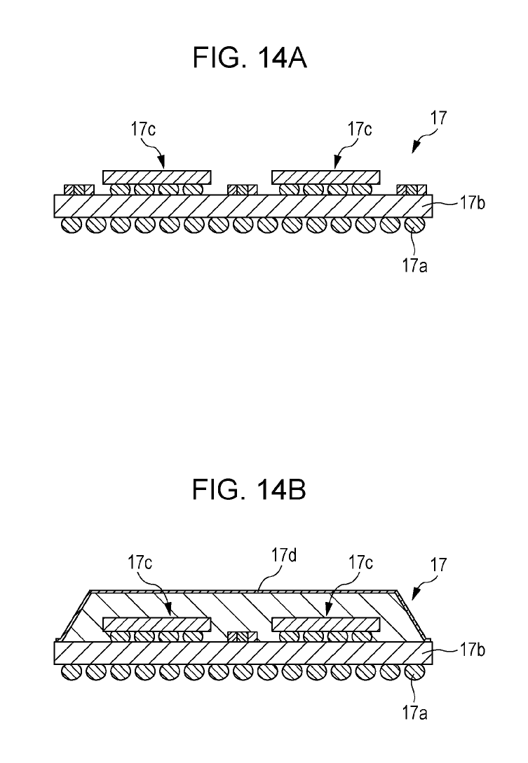

Meanwhile, as a semiconductor package, a multi-chip package 17 with solder bumps 17a and with a plurality of semiconductor chips 17c mounted on a package board 17b has been used in recent years, as depicted in FIG. 14A and FIG. 14B. Also, the multi-chip package may have a hollow package cover 17d mounted thereon (for example, refer to FIG. 14B).

In the case of this multi-chip package, it is difficult to make the heat transfer cap described in Japanese Laid-open Patent Publication No. 2011-211073 abut on the upper surface of the package board. Moreover, in the case of a multi-chip package with a package cover mounted thereon, even if the heat transfer cap is made abut on the package cover to supply heat to the solder joint parts, it is difficult to supply sufficient heat to the solder joint parts. Furthermore, it may be thought that heat is supplied from around the multi-chip package via the printed board to the solder joint parts so that a lower end of each side wall of the heat transfer cap is in contact with an upper surface of the printed board around the multi-chip package as a replacement target component. However, this may be impractical because the printed board may be overheated.

As such, it is difficult to melt the solder joint part of this multi-chip package by using the repairing apparatus described in Japanese Laid-open Patent Publication No. 2011-211073.

Thus, it is desirable to provide a heat transfer cap, a repairing apparatus including the heat transfer cap, and a repairing method capable of reliably supplying heat to the solder joint part of the electronic component even if a multi-chip package is included as an electronic component solder-jointed to a wiring board such as a printed board.

FIGS. 14A and 14B illustrate, as a semiconductor package, a multi-chip package 17 with solder bumps 17a and with a plurality of semiconductor chips 17c mounted on a package board 17b has been used in recent years, as depicted in FIG. 14A and FIG. 14B. Also, the multi-chip package may have a hollow package cover 17d mounted thereon (for example, refer to FIG. 14B).

In the case of this multi-chip package, it is difficult to make the heat transfer cap described in Japanese Laid-open Patent Publication No. 2011-211073 abut on the upper surface of the package board. Moreover, in the case of a multi-chip package with a package cover mounted thereon, even if the heat transfer cap is made abut on the package cover to supply heat to the solder joint parts, it is difficult to supply sufficient heat to the solder joint parts. Furthermore, it may be thought that heat is supplied from around the multi-chip package via the printed board to the solder joint parts so that a lower end of each side wall of the heat transfer cap is in contact with an upper surface of the printed board around the multi-chip package as a replacement target component. However, this may be impractical because the printed board may be overheated.

As such, it is difficult to melt the solder joint part of this multi-chip package by using the repairing apparatus described in Japanese Laid-open Patent Publication No. 2011-211073. Thus, it is desirable to provide a heat transfer cap, a repairing apparatus including the heat transfer cap, and a repairing method capable of reliably supplying heat to the solder joint part of the electronic component even if a multi-chip package is included as an electronic component solder-jointed to a wiring board such as a printed board.

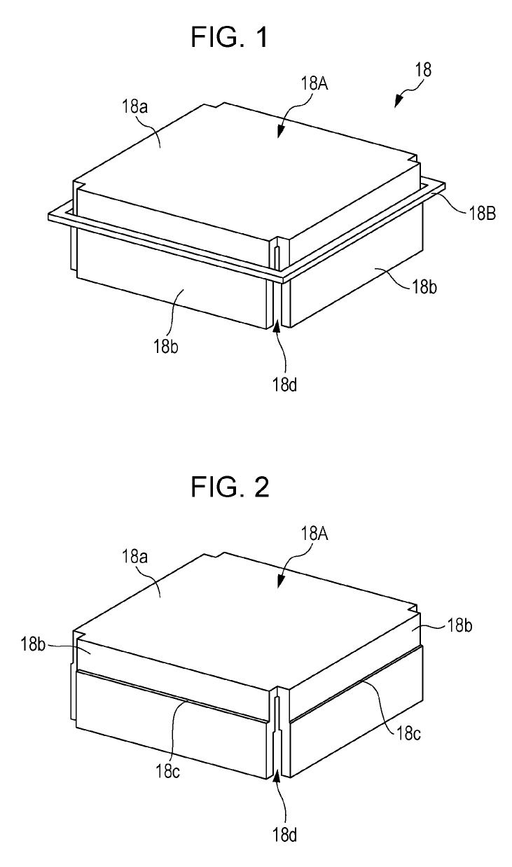

Hereinafter, a heat transfer cap, a repairing apparatus, and a repairing method according to embodiments of the present disclosure are described with reference to the FIG. 1 to FIG. 14B. The repairing apparatus according to the present embodiment is an apparatus for replacing an electronic component solder-jointed to a wiring board. Examples of the electronic component include a semiconductor package such as a BGA package, and a semiconductor chip. Here, examples of the semiconductor package include a single-chip package, a multi-chip package 17, for example, refer to FIG. 14A and FIG. 14B, and a multi-chip package 17 with a hollow package cover 17d mounted thereon, for example, refer to FIG. 14B, and these packages may be configured as a BGA package. Note that the multi-chip package may be referred to as a multi-tip module, a multi-chip module package, or a multi-chip BGA package. Also, examples of the wiring board include a printed board and a package board.

Hereinafter, in a printed board unit in which the multi-chip BGA package 17 with the hollow package cover 17d mounted thereon (for example, refer to FIG. 14B) is solder-jointed to the printed board by using SΔC solder, an example of replacing the multi-chip BGA package is described.

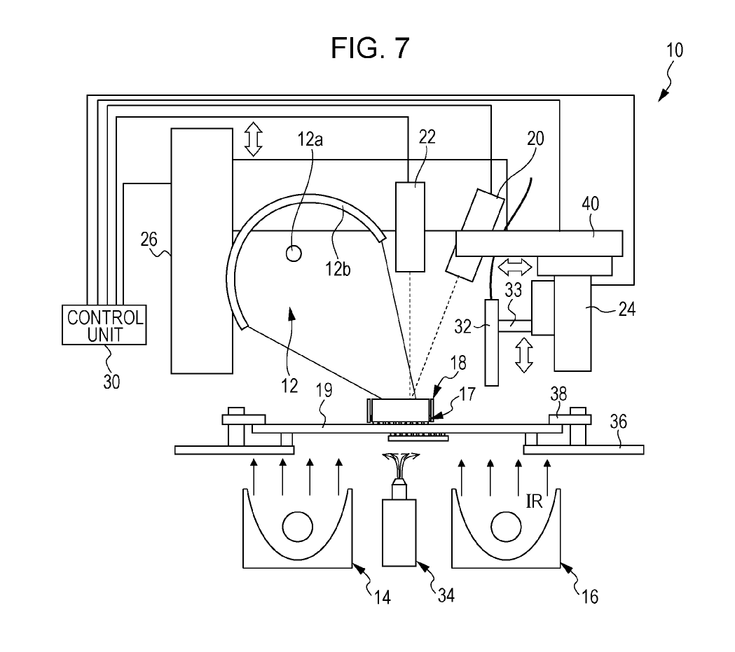

A repairing apparatus 10 includes, as depicted in FIG. 7, a heat transfer cap 18 for supplying heat to solder joint parts 17a of the multi-chip BGA package 17 solder-jointed to a printed board 19. The heat transfer cap 18 is also referred to as a heat transfer cap for repair, a heat transfer cap member, or a heat transfer cap member for repair. The repairing apparatus 10 is also referred to as an electronic component repairing apparatus.

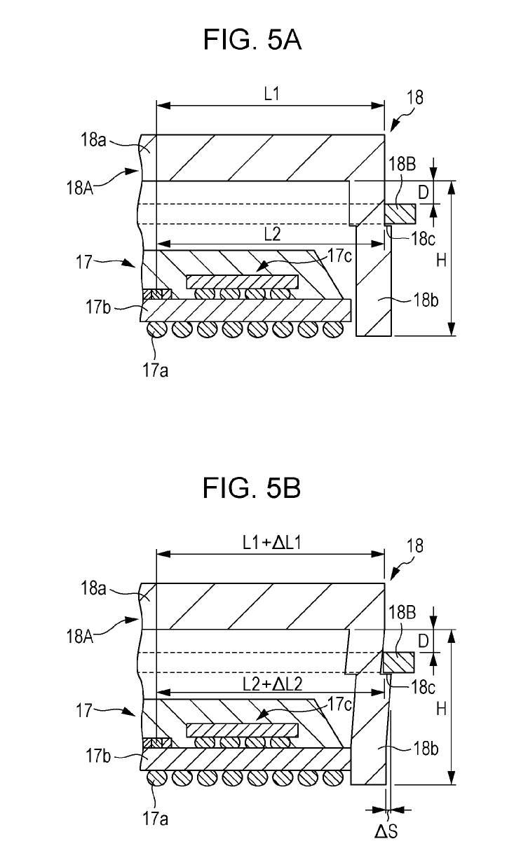

In the present embodiment, as depicted in FIG. 1, the heat transfer cap 18 includes a cap unit 18A with which the multi-chip BGA package 17 (for example, refer to FIG. 5A and FIG. 5B) is covered and which has side walls 18b to be in contact with side surfaces of the multi-chip BGA package 17 at the time of heating, and a ring unit 18B mounted outside the side walls 18b of the cap unit 18A and having a linear expansivity smaller than a linear expansivity of the cap unit 18A. The linear expansivity is also referred to as a coefficient of linear expansion, a rate of thermal expansion, or a coefficient of thermal expansion. The cap unit 18A is also referred to as a cap member. The ring unit 18B is also referred to as a ring member.

Here, as depicted in FIG. 2, the cap unit 18A includes a quadrangular flat part (a flat plate part) 18a and four side walls (side plate parts) 18b continued to respective sides of this flat part 18a. That is, the cap unit 18A includes four side walls 18b in contact with four side surfaces of the multi-chip BGA package 17 (for example, refer to FIG. 5A and FIG. 5B) at the time of heating. With this cap unit 18A, the multi-chip BGA package 17 is covered, with the flat part 18a positioned on an upper side. That is, with the flat part 18a positioned on an upper side, the cap unit 18A has a lower side open, and an inner space defined by the flat part 18a and each of the side walls 18b serves as a space for accommodating the multi-chip BGA package 17. The cap unit 18A also has dimensions so that the respective side walls 18b are in contact with the side surfaces of the multi-chip BGA package 17 at the time of heating. In particular, the cap unit 18A preferably has dimensions so that the respective side walls 18b grip the side surfaces of the multi-chip BGA package 17 at the time of heating. Since the flat part 18a is a portion to be radiated and heated with light from the light source 12a (for example, refer to FIG. 7), the flat part 18a is also referred to as a heat part. Also, since each side wall 18b is a portion that transmits heat from the heat part, each side wall 18b is also referred to as a heat transfer part.

In the present embodiment, a slit 18d is provided at each of four corners of the heat transfer cap 18, that is, between the four side walls 18b. Each slit 18d extends from the corner of the flat part 18a to the tip of the side wall 18b. As such, these four side walls 18b are not connected but separated from one another. With this, by using a difference between thermal expansion of the cap unit 18A of the heat transfer cap 18 and subtle thermal expansion of the ring unit 18B at the time of heating, the four side walls 18b are easily deformable toward inside at the time of heating. That is, the four side walls 18b are sufficiently bent toward the inside at the time of heating, and return at the time of non-heating.

Also, the ring unit 18B has a rectangular shape as depicted in FIG. 1, fitting in the outside of the four side walls 18b of the cap unit 18A.

Also, the cap unit 18A may be made of a metal with a linear expansivity of 17.5×10⁻⁶ 1/K to 20×10⁻⁶ 1/K and a coefficient of thermal conductivity equal to or higher than 100 W/mK. For example, the cap unit 18A may be made of a metal such as brass, have a linear expansivity on the order of 17.5×10⁻⁶ 1/K to 20×10⁻⁶ 1/K, and have a coefficient of thermal conductivity on the order of 100 W/mK. The ring unit 18B may be made of a ceramic or metal with a linear expansivity of 3×10⁻⁶ 1/K to 7×10⁻⁶ 1/K. For example, the ring unit 18B may be made of a ceramic-based material such as alumina and have a low linear expansivity of 3×10⁻⁶ 1/K to 7×10⁻⁶ 1/K. As such, the heat transfer cap 18 includes two components 18A and 18B that are different in linear expansivity.

Furthermore, in the present embodiment, as depicted in FIG. 2, each of the side walls 18b of the cap unit 18A includes a level difference 18c to hold the ring unit 18B on an outer surface. That is, each of the side walls 18b of the cap unit 18A includes the level difference 18c so that a lower portion is positioned outside an upper portion, that is, the level difference 18c in a thickness direction. With this, the ring unit 18B fitting in the outside of each of the side walls 18b of the cap unit 18A stops at, for example, a predetermined height of each of the side walls 18b of the cap unit 18A. The position of the ring unit 18B is defined by the position where this level difference 18c is provided in a vertical direction in a height direction (a vertical direction) of each of the side walls 18b of the cap unit 18A. By the position in the vertical direction of the ring unit 18B on each of the side walls 18b of the cap unit 18A, a displacement amount (in turn, a gripping force) of each of the side walls 18b of the cap unit 18A in an inner direction at the time of heating is defined. For this reason, the level difference 18c provided to each of the side walls 18b of the cap unit 18A allows the displacement amount (in turn, the gripping force) of each of the side walls 18b of the cap unit 18A in the inner direction at the time of heating to be kept the same.

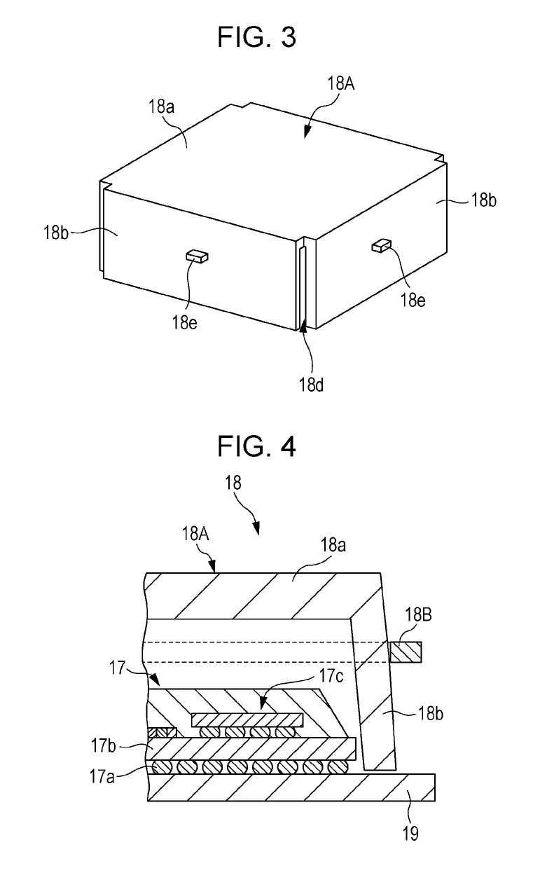

The above is not meant to be restrictive. For example, as depicted in FIG. 3, the side walls 18b of the cap unit 18A may each include a projection 18e to hold the ring unit 18B on an outer surface. Also, for example, as depicted in FIG. 4, the side walls 18b of the cap unit 18A may be tilted to hold the ring unit 18B on an outer surface. As such, the ring unit 18B is sufficient as long as the ring unit 18B is mounted on the outer surface of each of the side walls 18b of the cap unit 18A.

Also, in the heat transfer cap 18, for high temperature by efficiently receiving radiation of light, excellent optical energy absorption (heat absorption), and stable temperature measurement, which will be described further below, at least the flat part 18a is preferably coated with, for example, black chromic oxide coating or subjected to black anodized aluminum processing (anodizing process) or black plating. Furthermore, a face of each of the side walls 18b of the heat transfer cap 18 to be in contact with the side surface of the multi-chip BGA package 17 is preferably provided with an adhesive material, heat transfer grease such as heat transfer silicone, or heat transfer sheet to reduce contact heat resistance due to roughness of the side surfaces of the multi-chip BGA package 17 to efficiently transfer heat.

In the heat transfer cap 18 configured as described above, when the cap unit 18A is heated with radiation of light from a light source 12a (for example, refer to FIG. 7) to heat the cap unit 18A, each of the side walls 18b of the cap unit 18A tends to be expansion outside. However, since such expansion is inhibited by the ring unit 18B with a small linear expansivity, and therefore each of the side walls 18b of the cap unit 18A is pushed back inside (refer to FIG. 5B). Then, each of the pushed side walls 18b of the cap unit 18A is brought into contact with a side surface of the multi-chip BGA package 17 (here, a side surface of the package board 17b, for example, refer to FIG. 5B). That is, with the cap unit 18A being deformed by heat, the side walls 18b of the cap unit 18A are respectively brought into contact with the side surfaces of the multi-chip BGA package 17. With this, heat from the heat transfer cap 18 is transmitted from each side surface (outer edge) of the packaged substrate 17b to the solder joint parts 17a, thereby allowing SΔC solder configuring the solder join parts 17a to be heated and melted.

With the heat transfer cap 18 heated by radiating the heat transfer cap 18 with light, the side walls 18b of the heat transfer cap 18 is brought into contact with the respective side surfaces of the multi-chip BGA package 17, and heat is supplied from each of the side surfaces of the multi-chip BGA package 17 to the solder joint parts 17a, thereby the solder joint parts 17a are heated to melt. That is, while it is difficult to melt the solder joint parts of the multi-chip package in the heat transfer cap described in Japanese Laid-open Patent Publication No. 2011-211073, the use of the heat transfer cap 18 of the present embodiment allows the solder joint parts 17a of the multi-chip BGA package 17 to be melted. As such, the heat transfer cap 18 of the present embodiment may be used in a repairing apparatus 10 (for example, refer to FIG. 7) capable of reducing heat influences to an electronic component that surrounds a replacement target component for replacement of not only a single-chip package but also a multi-chip package which may be one with a mounted component exposed therefrom or one with a package cover mounted thereon, for example, refer to FIG. 14A and FIG. 14B.

On the other hand, the side walls 18b of the cap unit 18A are in contact with the respective side surfaces of the multi-chip BGA package 17 at the time of heating but are not in contact with the respective side surfaces of the multi-chip BGA package 17 at the time of non-heating. For this reason, the cap unit 18A, that is, the heat transfer cap 18, is easily removed and fitted. “At the time of heating” refers to a time during which the heat transfer cap 18 is being heated, when the temperature of the heat transfer cap 18 is high and the heat transfer cap 18 is deformed. “At the time of non-heating” refers to a time during which the heat transfer cap 18 is not being heated, when the temperature of the heat transfer cap 18 is sufficiently low and the heat transfer cap 18 is not deformed.

Also, with deformation (elastic deformation) of the cap unit 18A by heating, the side surfaces of the multi-chip BGA package 17 may be gripped by the respective side walls 18b of the cap unit 18A. That is, with deformation of the respective side walls 18b of the cap unit 18A in an inner direction at the time of heating, a gripping force (a clamp force) for gripping the respective side surfaces of the multi-chip BGA package 17 may be generated on the respective side walls 18b of the cap unit 18A. As such, with the respective side surface of the multi-chip BGA package 17 gripped by the respective side walls 18b of the cap unit 18A, the respective side walls 18b of the cap unit 18A are allowed to be sufficiently in contact with the respective side surfaces of the multi-chip BGA package 17. With this, heat from the cap unit 18A is allowed to be sufficiently transmitted to the solder joint parts 17a of the multi-chip BGA package 17. The cap unit 18A is also referred to as a clamp cap unit. Each of the side walls 18b of the cap unit 18A is also referred to as a clamp unit.

Next, a deformation mechanism (a clamp mechanism) of the heat transfer cap at the time of heating is specifically described with reference to FIG. 5A and FIG. 5B. Here, FIG. 5A is a sectional view of the state of the heat transfer cap 18 at the time of non-heating (at ordinary temperatures), and FIG. 5B is a sectional view of the state of the heat transfer cap 18 at the time of heating. FIG. 5A and FIG. 5B depict the state in which the multi-chip BGA package 17 is covered with the heat transfer cap 18, and depict only one side from the center of the heat transfer cap 18.

In FIG. 5A and FIG. 5B, L1 denotes a length that is a half of the length of the cap unit 18A (the flat part 18a), L2 denotes a length that is a half of an inner dimension of the ring unit 18B, and a relation of L1=L2 holds at ordinary temperatures. D denotes a length from a lower surface of the flat part 18a of the cap unit 18A to an upper surface of the ring unit 18B. H denotes a length from the lower surface of the flat part 18a of the cap unit 18A to the tip of each side wall 18b of the cap unit 18A (the lower surface corresponds to the bottom surface of the cap unit 18A). ΔL1 is a change amount of the length L1 or a length of extension of the length L1, which is a half the length of the cap unit 18A, at the time of heating, and ΔL2 is a change amount of the length L2 or a length of extension of the length L2, which is a half of the inner dimension of the ring unit 18B, at the time of heating. Also, ΔS is a displacement amount of each side wall 18b of the cap unit 18A.

At ordinary temperatures, as depicted in FIG. 5A, there is a gap between the side wall 18b of the cap unit 18A and the side surface of the multi-chip BGA package 17, and the gap is approximately 0.1 mm herein. As such, the heat transfer cap 18 is easily removable since the heat transfer cap 18 covers the multi-chip BGA package 17 with the space. By contrast, at the time of heating, as depicted in FIG. 5B, the heat transfer cap 18 is deformed, and the side wall of the cap unit is displaced in the inner direction. That is, at the time of heating, a difference between the change amount ΔL1 of the length L1 of the cap unit and the change amount ΔL2 of the length L2 of the ring unit causes the side wall 18b of the cap unit 18A where the ring unit 18B fits in outside to be bent in the inner direction with an upper ridge inside the ring unit 18B as a starting point, and the tip of the side wall 18b is displaced in the inner direction by ΔS.

Here, when it is assumed that the multi-chip BGA package 17 has a size (horizontal and vertical length) of approximately 40 mm and the side wall 18b of the cap unit 18A has a thickness of approximately 0.9 mm, since the gap between the side wall 18b of the cap unit 18A and the side surface of the multi-chip BGA package 17 is approximately 0.1 mm, L1=L2=21 mm holds. Also, when it is assumed that the multi-chip BGA package 17 has a thickness of approximately 5 mm and a margin of approximately 1 mm is provided from the upper surface of the multi-chip BGA package 17 to the lower surface of the cap unit 18A (the flat part 18a), H is approximately 6 mm. Here, D is assumed to be approximately 1 mm.

For the cap unit 18A, brass with good heat conduction is used, and a linear expansivity α1 is approximately 17.5×10⁻⁶ 1/K. For the ring unit 18B, alumina (Al₂O₃) is used, and a linear expansivity α2 is approximately 6.4×10⁻⁶ 1/K.

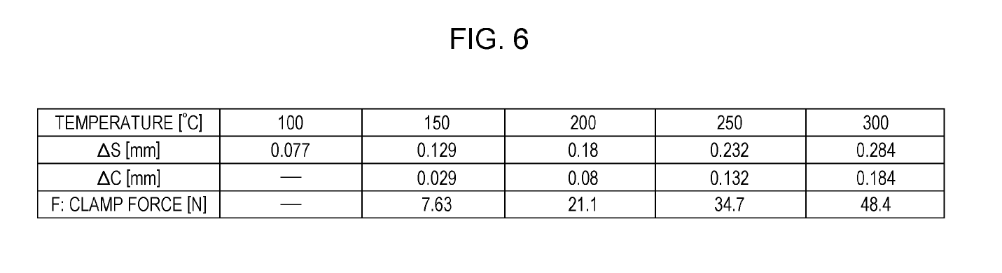

In this case, when ΔL1, ΔL2, and ΔS are calculated by using the following Equations (1) to (3) with an ordinary temperature T_{R} being set at approximately 25° C. and a temperature at the time of heating (a heating temperature at the time of rework) T_{H} being set at approximately 250° C., ΔS is approximately 0.232 mm as depicted in FIG. 6. Note that ΔL2 is subtracted in Equation (3) in order to exclude a portion stretched by heat in a direction opposite to an inner direction.

ΔL1=α1·(T_{H}−T_{R})·L1 (1)

ΔL2=α2·(T_{H}−T_{R})·L2 (2)

ΔS=(ΔL1−ΔL2)·(H−D)/D−ΔL2 (3)

Thus calculated value of ΔS, approximately 0.232 mm, is larger than a gap between any side wall 18b of the cap unit 18A and any side surface of the multi-chip BGA package 17 at the ordinary temperature (approximately 0.1 mm). For this reason, the side wall 18b of the cap unit 18A is in contact with the side surface of the multi-chip BGA package 17 at the time of heating. In this case, in consideration of the gap of approximately 0.1 mm at the ordinary temperature, a displacement amount ΔC for contribution as a gripping force (a clamp force) is approximately 0.132 mm, which is obtained by subtracting the gap of approximately 0.1 mm from the value of ΔS of approximately 0.232 mm. With this value of the displacement amount ΔC of approximately 0.132 mm, a gripping force F of approximately 34.7 N may be generated with respect to the side surface of the multi-chip BGA package 17, thereby obtaining sufficient contact for heat transfer and gripping.

Similarly, when the temperature at the time of heating is set at approximately 150° C., approximately 200° C., and approximately 300° C., ΔS is approximately 0.129 mm, approximately 0.18 mm, and approximately 0.284 mm, respectively, as depicted in FIG. 6. Also, ΔC is approximately 0.029 mm, approximately 0.08 mm, and approximately 0.184 mm, respectively. The gripping force F that occurs is approximately 7.63 N, approximately 21.1 N, and approximately 48.4 N, respectively, thereby obtaining sufficient contact for heat transfer and gripping.

This gripping force may be adjusted by changing the thickness of each side wall 18b of the cap unit 18A. Thus, it is sufficient to adjust the thickness of the side wall 18b of the cap unit 18A in consideration of the temperature at the time of heating, the displacement amount for heat transfer, and the gripping force. It is preferable to consider the fact that the gripping force varies depending on the height position of the level difference 18c provided on each side wall 18b of the cap unit 18A, that is, the height position of the ring unit 18B.

With this, the solder joint parts 17a of the multi-chip BGA package 17 are sufficiently heated and melted. Also, the multi-chip BGA package 17 is gripped by the heat transfer cap 18, thereby allowing the heat transfer cap 18 gripping the multi-chip BGA package 17 to be suctioned for transfer, as will be described further below.

Next, a repairing apparatus 10 including the heat transfer cap 18 configured as described above is described with reference to FIG. 7.

The repairing apparatus 10 includes at least the heat transfer cap 18 described above and the light source 12a that radiates the heat transfer cap 18 with light to heat the heat transfer cap 18.

Specifically, the repairing apparatus includes an upper light source unit 12, lower light source units 14 and 16, the heat transfer cap 18, a temperature measuring unit 20, a displacement measuring unit 22, a first lift 24, a second lift 26, a mover 40, a control unit 30, a suction nozzle 32, a hot air generating unit 34, a stage 36, and a board holder 38.

The upper light source unit 12 has the light source 12a and a reflecting plate 12b, and the heat transfer cap 18 is radiated with far infrared light (IR) from the light source 12a. That is, the upper light source unit 12 heats the heat transfer cap 18 with radiation energy transmission. The reflecting plate 12b is formed so that light converges to a predetermined position. Since the upper light source unit 12 is fixed to an arm unit 26b of the second lift 26, the upper light source unit 12 moves with the movement of the arm unit 26b of the second lift 26. A spot diameter when light converges with the reflecting plate 12b is on the order of 3 mm, for example. In FIG. 7, a light beam for radiation is depicted as being wide. For example, a halogen lamp, a xenon lamp, or a laser light source may be used as the light source 12a.

The lower light source units 14 and 16 radiate a portion surrounding a position on a side opposite to the side of a mount position of the printed board (wiring board) 19 having the multi-chip BGA package 17 mounted thereon (this opposite side is hereinafter referred to as a rear side) with far infrared light, thereby heating with radiation energy transmission. This heating is performed to make the printed board 19 not to become warped due to thermal expansion caused by part of the mount side heated by the upper light source unit 12. The lower light source units 14 and 16 uniformly heat the entire printed board 19 at a temperature lower than a melting temperature of the solder joint parts 17a by, for example, approximately 70° C. This reduces the heating time with light radiation by the upper light source unit 12.

Furthermore, hot air is blown by the hot air generating unit 34 at a corresponding position on the rear side of the mount position of the multi-chip BGA package 17 across the printed board 19. That is, the printed board 19 is heated by convection energy transmission. The hot air generating unit 34 blows hot air at temperatures of, for example, 180° C. to 220° C., from the rear side, at a flow velocity of, for example, 3 ml/min. to 20 ml/min. Hot air is blown so that the rear side of a mount area of the printed board 19 does not have a temperature higher than the melting temperature of the solder joint parts 17a due to heating with light radiation from the upper light source unit 12 and heating with light radiation by the lower light source units 14 and 16. With this, excessive heating of the area on the rear side of the mount position is suppressed, thereby suppressing an increase in temperature of the solder joint parts 17a.

The temperature measuring unit 20 measures the temperature of the flat part 18a of the heat transfer cap 18. For example, the temperature measuring unit 20 measures the temperature by detecting infrared radiation energy. The results of temperature measurement are sent to the control unit 30.

The control unit 30 controls ON and OFF of light radiation by the light source 12a according to the result of temperature measurement transmitted from the temperature measuring unit 20. Even with the control of ON and OFF of the light source 12a to control the heating temperature, since the heat transfer cap 18 is used, the heating temperature of the solder joint parts 17a is smoothly changed. In this manner, the temperature of the flat part 18a of the heat transfer cap 18 is controlled at a predetermined temperature.

In the present embodiment, by obtaining in advance a relation between the temperature of the flat part 18a as a target for temperature measurement and the temperature of the solder joint parts 17a of the multi-chip BGA package 17, the temperature of the flat part 18a when the solder joint parts 17a reach the melting point of solder may be set at a target temperature.

In the present embodiment, by using the heat transfer cap 18 described above, the solder joint parts 17a may be melted while the heating temperature of the multi-chip BGA package 17 and the heating temperature of the surrounding electronic component are equal to or lower than an upper limit of a heat-resistant temperature. Therefore, by controlling the temperature of the flat part 18a at the target temperature, efficient repair is performed without providing heat influences to the multi-chip BGA package 17 and the surrounding electronic component.

The displacement measuring unit 22 measures the position of the flat part 18a along a vertical direction with respect to a surface of the printed board 19. As the displacement measuring unit 22, a laser displacement gage is used, for example. When the multi-chip BGA package 17 is repaired by using the heat transfer cap 18, a subtle displacement occurs also to the heat transfer cap 18 at the time of melting of the solder joint parts 17a. By detecting this subtle displacement of the heat transfer cap 18 at the time of melting of solder with the use of the displacement measuring unit 22, a melting start time of the solder joint parts 17a may be known. Measurement data of the displacement measuring unit 22 is sent to the control unit 30, and the control unit 30 monitors the presence or absence of a subtle displacement of the heat transfer cap 18. The control unit 30 determines the presence or absence of a subtle displacement of the heat transfer cap 18 by determining whether the measurement data exceeds a threshold. When determining that a subtle displacement has occurred, the control unit 30 causes light radiation by the light source 12a to stop after a predetermined time from the time of determination has passed, for example, after a lapse of approximately five seconds.

In the present embodiment, the melting start time of the solder joint parts 17a may be determined by the displacement measuring unit 22 and the control unit 30. This dispenses with a work of obtaining, in advance, information about the heating time until solder is melted, a temperature profile of each portion of the multi-chip BGA package 17, a temperature profile of each portion of the printed board 19, or the like.

The first lift 24 and the mover 40 are a mechanism of transferring the multi-chip BGA package 17 and the heat transfer cap 18 to remove the multi-chip BGA package 17 from the printed board 19.

The first lift 24 includes an arm unit 33 that moves in a vertical direction. On this arm unit 33, the suction nozzle 32 that suctions the heat transfer cap 18 gripping the multi-chip BGA package 17 is mounted. The operation of the suction nozzle 32 and the arm unit 33 is controlled with a control signal from the control unit 30.

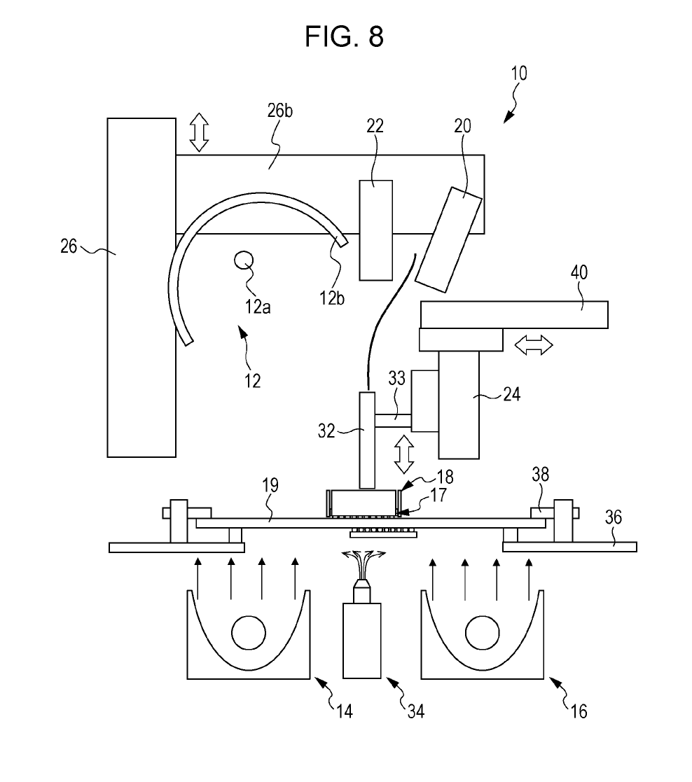

In the present embodiment, the displacement of the heat transfer cap 18 is measured to detect the melting start time of the solder joint parts 17a at the time of heating. At the time of heating, as depicted in FIG. 7, the suction nozzle 32 is retracted from above the heat transfer cap 18. Then, after the end of heating, as depicted in FIG. 8, the suction nozzle 32 is moved by the mover 40 to a position above the center position of the heat transfer cap 18, and then the suction nozzle 32 is lowered by the first lift 24 to be brought into contact with the upper surface of the heat transfer cap 18. Then, the heat transfer cap 18 gripping the multi-chip BGA package 17 is suctioned by the suction nozzle 32, and the heat transfer cap 18 in this state is moved by the first lift 24 and the mover 40, thereby removing the multi-chip BGA package 17 from the printed board 19 for transfer.

The second lift 26 includes an arm unit 26b that moves in a vertical direction. To this arm unit 26b, the upper light source unit 12, the temperature measuring unit 20, and the displacement measuring unit 22 are fixed. To transfer the multi-chip BGA package 17 and the heat transfer cap 18, as depicted in FIG. 8, the upper light source unit 12, the temperature measuring unit 20, and the displacement measuring unit 22 are retracted upward by the second lift 26. On the other hand, to radiate the heat transfer cap 18 with light for heating, as depicted in FIG. 7, the upper light source unit 12, the temperature measuring unit 20, and the displacement measuring unit 22 are moved downward by the second lift 26 so that the light convergence position is at a center position of the flat part 18a of the heat transfer cap 18.

The control unit 30 controls the upper light source unit 12, the lower light source units 14 and 16, the hot air generating unit 34, the first lift 24, the second lift 26, the mover 40, and an ejector 41, based on the measurement data of the temperature measuring unit 20 and the displacement measuring unit 22.

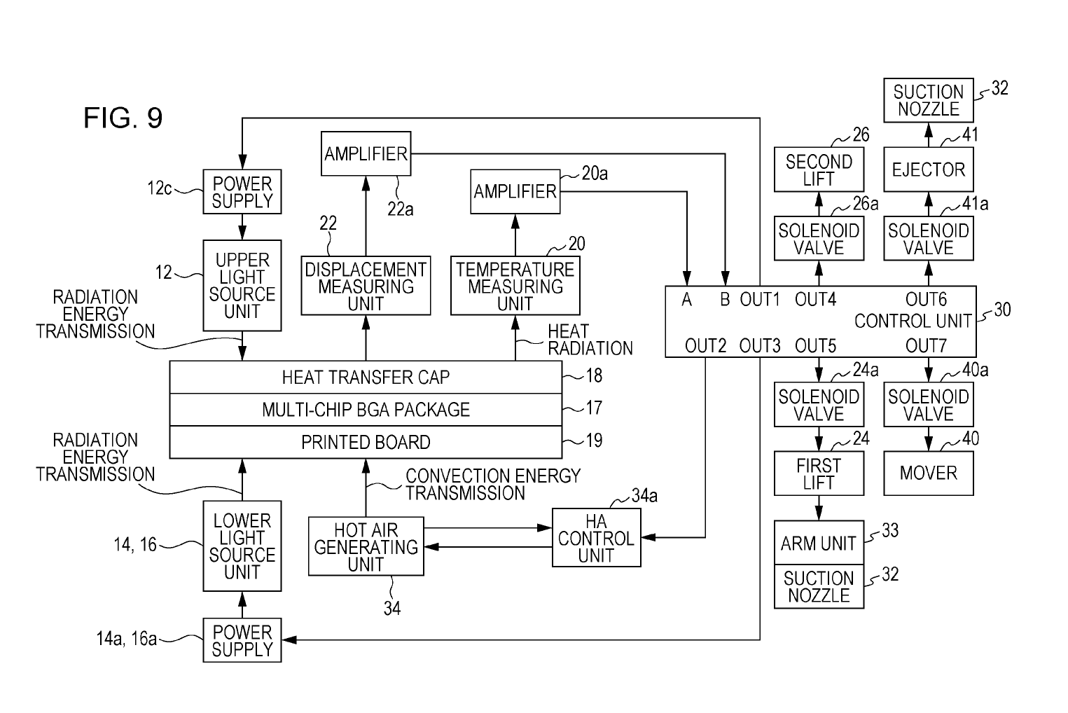

Here, FIG. 9 is a control block diagram focusing on the control unit 30.

In FIG. 9, an amplifier 20a amplifies measurement data of the temperature measured by the temperature measuring unit 20 at a predetermined scaling factor. When the amplified measurement data exceeds a predetermined threshold, a binary signal is set at a high level. When the amplified measurement data does not exceed the threshold, the binary signal is set at a low level. Then, the amplifier 20a sends the binary signal to the control unit 30. Therefore, the control unit 30 controls the light source 12a so that the upper light source unit 12 is turned OFF when the level of the binary signal is changed from 0 to 1 and the upper light source unit 12 is turned ON when the level of the binary signal is changed from 1 to 0. That is, the control unit 30 controls ON and OFF of the upper light source unit 12 through the power supply 12c based on the level of the binary signal generated by the amplifier 20a. With this, the heating temperature of the heat transfer cap 18 is controlled at a predetermined temperature.

Furthermore, the control unit 30 detects the melting start time of the solder joint parts 17a based on the measurement data of the displacement measured by the displacement measuring unit 22 and amplified by an amplifier 22a. When the solder joint parts 17a start melting, the solder joint parts 17a slightly crush to cause the heat transfer cap 18 to be displaced downward. The control unit 30 uses this displacement. After a predetermined time has elapsed after the detection of the melting start time based on the displacement of the heat transfer cap 18, the control unit 30 controls power supplies 12c, 14a, and 16a so as to stop light radiation of the upper light source unit 12 and the lower light source units 14 and 16. Furthermore, with control via an HA control unit 34a, the control unit 30 causes the blowing of hot air by the hot air generating unit 34 to stop.

Still further, the control unit 30 causes the first lift 24 to operate by activating a solenoid valve 24a, and also causes the mover 40 to operate by activating a solenoid valve 40a. With this, the suction nozzle 32 is retracted from above the heat transfer cap 18 at the time of heating for melting the solder joint units 17a (refer to FIG. 7). On the other hand, at the time of removal of the multi-chip BGA package 17, the suction nozzle 32 is moved to bring the tip of the suction nozzle 32 into contact with the upper surface of the heat transfer cap 18 (refer to FIG. 8). Then, the control unit 30 activates the ejector 41 capable of generating vacuum via a solenoid valve 41a to cause the suction nozzle 32 to suction the heat transfer cap 18 gripping the multi-chip BGA package 17. Then, with the heat transfer cap 18 suctioned by the suction nozzle 32, the suction nozzle 32 is moved by the first lift 24 and the mover 40 to remove the multi-chip BGA package 17 from the printed board 19 for transfer. While the multi-chip BGA package 17 is removed at the time of non-heating, the temperature of the heat transfer cap 18 is high to some extent, and the heat transfer cap 18 is deformed to a degree of gripping the multi-chip BGA package 17.

Still further, the control unit 30 causes a solenoid valve 26a to be activated to cause the second lift 26 to operate. With this, at the time of heating to melt the solder joint parts 17a, the upper light source unit 12, the temperature measuring unit 20, and the displacement measuring unit 22 are moved to respective predetermined positions (refer to FIG. 7), and the heat transfer cap 18 is radiated with light for heating. On the other hand, at the time of removal of the multi-chip BGA package 17, the upper light source unit 12, the temperature measuring unit 20, and the displacement measuring unit 22 are retracted so as not to hinder the movement of the suction nozzle 32 (refer to FIG. 8).

The stage 36 is configured to position the printed board 19 so that the mount position of the multi-chip BGA package 17 on the printed board 19 is at a predetermined position of the repairing apparatus 10. Also, the board holder 38 is to unmovably fix the positioned printed board 19.

Next, a repairing method using the repairing apparatus 10 is described.

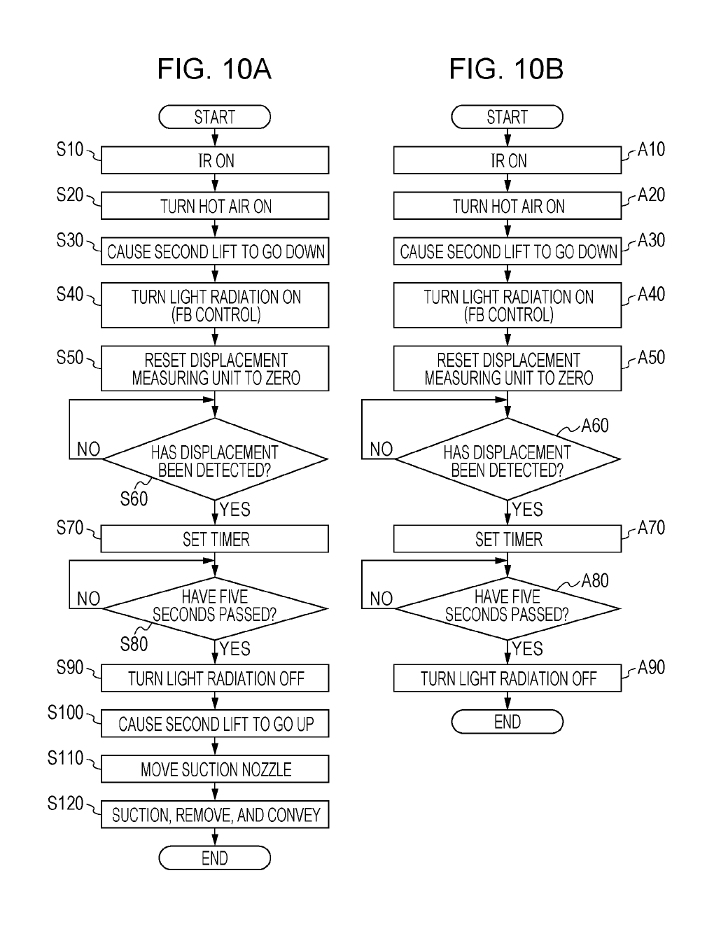

First, a method of removing the multi-chip BGA package 17 from the printed board 19 by using the repairing apparatus 10 is described with reference to FIG. 10A.

First, the multi-chip BGA package 17 mounted on the printed board 19 is covered with the heat transfer cap 18 (refer to FIG. 8).

Next, by following an instruction from the control unit 30, the power supplies 14a and 16a (refer to FIG. 9) are turned ON, and the lower light source units 14 and 16 start radiation with far infrared light (IR) (step S10). Furthermore, the hot air generating unit 34 starts blowing of hot air on the rear surface of the printed board 19 at temperatures of, for example, 180° C. to 220° C. through the HA control unit 34a (refer to FIG. 9) (step S20).

Next, by following an instruction from the control unit 30, the upper light source unit 12, the temperature measuring unit 20, and the displacement measuring unit 22 are lowered by the second lift 26 to be moved to predetermined positions at the time of heating (step S30). With this, heating by light radiation is prepared.

Next, by following an instruction from the control unit 30, the light source 12a is turned ON via the power supply 12c, radiation of far infrared light (IR) from the light source 12a starts, and heating of the heat transfer cap 18 starts (step S40). Radiation of far infrared light (IR) is subjected to feedback control based on the measurement data obtained by measurement of the temperature measuring unit 20.

Next, the control unit 30 performs zero reset of the measurement data to take measurement data of the displacement measuring unit 22 indicating the current position of the heat transfer cap 18 as a reference (step S50). This allows the control unit 30 to monitor the melting start time of the solder joint parts 17a.

In this state, the control unit 30 waits until the displacement measuring unit 22 detects a displacement of the heat transfer cap 18 (step S60). That is, the control unit 30 waits until the melting start time of the solder joint parts 17a is detected.

When detecting the melting start time of the solder joint parts 17a, the control unit 30 sets a timer of the control unit 30 at a predetermined time, for example, five seconds (step S70), and the control unit 30 waits until a lapse of five seconds at the timer (step S80). After the lapse of the predetermined time, the control unit 30 controls light radiation of the light source 12a to OFF (step S90). The control unit 30 also controls the lower light source units 14 and 16 and the hot air generating unit 34 to OFF.

After the solder joint parts 17a are melted and light radiation is turned OFF in the manner as described above, by following an instruction from the control unit 30, the upper light source unit 12, the temperature measuring unit 20, and the displacement measuring unit 22 are raised by the second lift 26 to move to a retraction position (step S100).

Next, by following an instruction from the control unit 30, the suction nozzle 32 is moved by the first lift 24 and the mover 40 to bring the tip of the suction nozzle 32 into contact with the upper surface of the heat transfer cap 18 (step S110).

Then, by following an instruction from the control unit 30, the ejector 41 is activated to cause the suction nozzle 32 to suction the heat transfer cap 18 gripping the multi-chip BGA package 17. In this state, the multi-chip BGA package 17 is removed by the first lift 24 and the mover 40 from the printed board 19 for transfer (step S120). At this stage, the temperature of the heat transfer cap 18 is not so low, and the heat transfer cap 18 is still in a deformed state, in which the multi-chip BGA package 17 is kept gripped.

In this manner, the multi-chip BGA package 17 may be removed from the printed board 19 for transfer immediately after melting the solder joint parts 17a.

Next, a method of mounting the multi-chip BGA package 17 on the printed board 19 by using the repairing apparatus 10 is described with reference to FIG. 10B.

First, the multi-chip BGA package 17 is mounted at a mount position of the printed board 19. Next, the multi-chip BGA package 17 mounted at the mount position of the printed board 19 is covered with the heat transfer cap 18 (refer to FIG. 8).

Next, processes similar to the processes at step S10 to step S90 in the removal method described above are performed (steps A10 to A90).

Then, the heat transfer cap 18 may be removed from the multi-chip BGA package 17 after the temperature of the heat transfer cap 18 is sufficiently decreased and the heat transfer cap 18 is not gripping the multi-chip BGA package 17.

In this manner, the multi-chip BGA package 17 may be mounted on the printed board 19.

The repairing apparatus and the repairing method using this repairing apparatus are not meant to be restricted to above. For example, the heat transfer cap of the above-described embodiment may be used in a repairing apparatus similar to the repairing apparatus described in Japanese Laid-open Patent Publication No. 2011-211073, that is, a repairing apparatus including a holding unit in place of the suction nozzle, and a repairing method using this repairing apparatus.

Therefore, according to the heat transfer cap, the repairing apparatus, and the repairing method according to the present embodiments, even if a multi-chip module package is included as an electronic component solder-jointed to a wiring board, heat is advantageously supplied reliably to solder joint parts of the electronic component.

The present disclosure is not meant to be restricted to the structure described in each embodiment described above, and may be variously modified without deviating from the gist of the present disclosure.

For example, while the cap unit 18A includes four side walls 18b in the embodiments described above, this is not meant to be restrictive. For example, the cap unit may include two side walls to be respectively in contact with one side surface of the multi-chip BGA package and another side surface of the multi-chip BGA package opposite to the one side surface at the time of heating.

Also, for example, the structure of the cap unit 18A is not meant to be restricted to the structure of the embodiments described above.

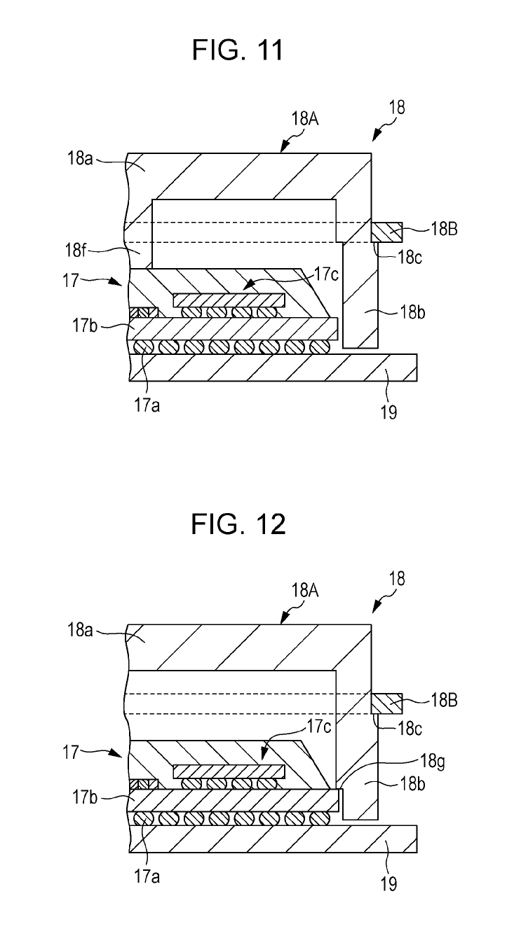

For example, as depicted in FIG. 11 and FIG. 12, the cap unit 18A may include a stopper 18f, 18g to make the tip of each of the side walls 18b not in contact with the printed board (wiring board) 19. This stopper 18f may be provided inside the cap unit 18A. For example, as depicted in FIG. 11, the stopper 18f may be configured of a projecting portion or a plate-shaped portion provided to a lower surface (for example, at the center) of the flat part 18a of the cap unit 18A. Also for example, as depicted in FIG. 12, the stopper 18g may be configured of a level difference provided inside a portion near the tip of each of the side walls 18b of the cap unit 18A. That is, the stopper 18g may be configured of a level difference provided so that a portion near the tip of each of the side walls 18b of the cap unit 18A is positioned outside the other portions.

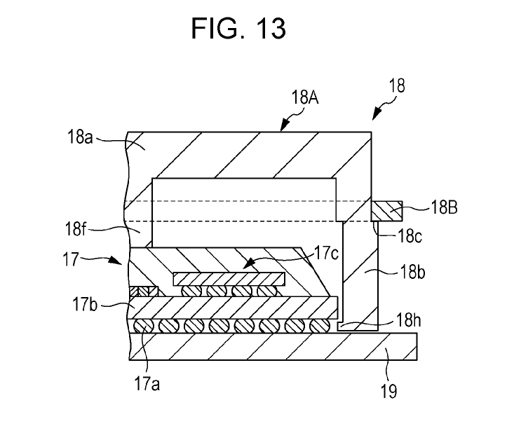

Furthermore, for example, as depicted in FIG. 13, the cap unit 18A may include a projection 18h to hold the multi-chip BGA package (electronic component) 17 at the tip of each of the side walls 18b. With this, the electronic component 17 may be gripped even if the displacement amount of the side walls 18b of the cap unit 18A is subtle at a temperature of, for example, approximately 100° C. For example, when the electronic component 17 is gripped by the heat transfer cap 18 for transfer, even if the temperature of the heat transfer cap 18 is decreased to, for example, approximately 100° C., the electronic component 17 is kept gripped by the heat transfer cap 18 for reliable transfer. While the heat transfer cap 18 includes the stopper 18f in addition to the projection 18h in FIG. 13, the heat transfer cap 18 may be configured not to include the stopper 18f but include the projection 18h.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A heat transfer cap comprising:
a cap unit configured to include side walls to be in contact with side surfaces of an electronic component during heating, the cap unit covering the electronic component solder-jointed to a wiring board; and
a ring unit mounted outside side walls of the cap unit, a linear expansivity of the ring unit being smaller than a linear expansivity of the cap unit.

2. The heat transfer cap according to claim 1, wherein
the side walls of the cap unit are four side walls to be respectively in contact with four side surfaces of the electronic component during heating, and the four side walls are separated from one another.

3. The heat transfer cap according to claim 1, wherein
the side walls of the cap unit are two side walls to be respectively in contact with one side surface of the electronic component and another side surface of the electronic component opposite to the one side surface during heating.

4. The heat transfer cap according to claim 1, wherein
the side walls of the cap unit each include a level difference to hold the ring unit on an outer surface.

5. The heat transfer cap according to claim 1, wherein
the side walls of the cap unit each include a projection to hold the ring unit on an outer surface.

6. The heat transfer cap according to claim 1, wherein
the cap unit includes a stopper to make the tip of each of the side walls not in contact with the wiring board.

7. The heat transfer cap according to claim 1, wherein
the cap unit includes a projection at a tip of each of the side walls to support the electronic component.

8. The heat transfer cap according to claim 1, wherein
the cap unit is made of a metal with a linear expansivity of 17.5×10⁻⁶ 1/K to 20×10⁻⁶ 1/K and a coefficient of thermal conductivity equal to or higher than 100 W/mK.

9. The heat transfer cap according to claim 1, wherein
the ring unit is made of a ceramic or metal with a linear expansivity of 3×10⁻⁶ 1/K to 7×10⁻⁶ 1/K.

10. A repairing apparatus comprising:
a heat transfer cap that supplies heat to a solder joint part of an electronic component solder-jointed to a wiring board; and
a light source configured to radiate the heat transfer cap with light to heat the heat transfer cap; wherein
the heat transfer cap includes,
a cap unit with which the electronic component is covered, the cap unit configured to have side walls to be in contact with side surfaces of the electronic component during heating, and
a ring unit mounted outside side walls of the cap unit and configured to have a linear expansivity smaller than a linear expansivity of the cap unit.

11. The repairing apparatus according to claim 10, wherein
the side walls of the cap unit are four side walls to be respectively in contact with four side surfaces of the electronic component during heating, and
the four side walls are separated from one another.

12. The repairing apparatus according to claim 10, wherein
the side walls of the cap unit are two side walls to be respectively in contact with one side surface of the electronic component and another side surface of the electronic component opposite to the one side surface at the time of heating.

13. The repairing apparatus according to claim 10, wherein
the side walls of the cap unit each include a level difference to hold the ring unit on an outer surface.

14. The repairing apparatus according to claim 10, wherein
the side walls of the cap unit each include a projection to hold the ring unit on an outer surface.

15. The repairing apparatus according to claim 10, wherein
the cap unit includes a stopper to make a tip of each of the side walls not in contact with the wiring board.

16. The repairing apparatus according to claim 10, wherein
the cap unit includes a projection at a tip of each of the side walls to support the electronic component.

17. The repairing apparatus according to claim 10, wherein
the cap unit is made of a metal with a linear expansivity of 17.5×10⁻⁶ 1/K to 20×10⁻⁶ 1/K and a coefficient of thermal conductivity equal to or higher than 100 W/mK.

18. The repairing apparatus according to claim 10, wherein
the ring unit is made of a ceramic or metal with a linear expansivity of 3×10⁻⁶ 1/K to 7×10⁻⁶ 1/K.

19. A repairing method comprising:
covering an electronic component on a wiring board with a transfer cap that includes a cap unit with side walls to be in contact with side surfaces of the electronic component at the time of heating and a ring unit mounted outside the side walls of the cap unit and configured to have a linear expansivity smaller than a linear expansivity of the cap unit; and
heating the heat transfer cap by radiating the heat transfer cap with light to supply heat to a solder joint part of the electronic component.
